(19) United States
(12) Patent Application Publication
(10) Pub. No.: US 2025/0207917 A1
(43) Pub. Date: Jun. 26, 2025

(54) RETRO-REFLECTOR ARRANGEMENT

(71) Applicant: HEXAGON TECHNOLOGY CENTER GMBH, Heerbrugg (CH)

(72) Inventors: Zheng YANG, Friedrichshafen (DE); Danick BRÜHLMANN, Staad (CH); Johan STIGWALL, St.Gallen (CH); Thomas JENSEN, Rorschach (CH)

(73) Assignee: HEXAGON TECHNOLOGY CENTER GMBH, Heerbrugg (CH)

(21) Appl. No.: 18/972,649

(22) Filed: Dec. 6, 2024

(30) Foreign Application Priority Data
Dec. 21, 2023 (EP) 23219304.5

(51) Int. Cl. G01C 15/06; G02B 5/13

(52) U.S. Cl. CPC G01C 15/06; G02B 5/13

(57) ABSTRACT

A reflector arrangement for determining a position and/or for marking a target point having at least two retro-reflecting elements, each of the at least two retro-reflecting elements comprises a respective front boundary surface configured for entry of measuring light into the respective retro-reflecting element and a respective back boundary surface configured for reflecting the measuring light as reflected measuring light, wherein the front boundary surface and the back boundary surface are arranged on opposite sides of the respective retro-reflecting element, and a respective optical axis defined by the arrangement of the front boundary surface and/or the back boundary surface of the respective retro-reflecting element. The front boundary surface and the back boundary surface of each of the at least two retro-reflecting elements are of curved shape.

### BACKGROUND

The disclosure relates generally to an optical arrangement, preferably for use in the field of industrial metrology or geodetic surveying, which provides retro-reflection of received measuring light.

Surveying systems for determining positions in the field of geodesy or the field of building or construction are diversely known. Examples thereof are systems consisting of a static surveying apparatus having a direction determination unit and a range meter, for example a total station, and a measuring aid instrument for marking a point to be measured or to be characterized, for example a pole. A geodetic measuring device of the prior art is described, for example, in the publication document EP 1 686 350. Layout systems are also known, consisting of a static laser emitter, which by means of a laser beam generates a position reference that can be received by a laser receiver at the point to be marked. Surveying activities are thus carried out by the interaction of a static apparatus, having a known location and therefore offering a position reference, with a receiving or marking, or targetable, measuring aid means, so that the position of individual terrain points such as land surveying points or points on construction site objects, for example in the interior or exterior region of buildings or in road construction, can be determined accurately with view to position measurement or staking-out.

With respect to the configuration of the surveying apparatuses, numerous different embodiments are known. For example, modern total stations have microprocessors for digital post-processing and storage of recorded measurement data. The apparatuses generally have a compact and integrated design, there usually being coaxial distance measuring elements as well as computation, control and storage units in an apparatus. Depending on the level of development of the total station, motorization of the targeting or sighting device and—in the case of using retroreflectors (for instance an all-round prism) as target objects—means for automatic target searching and tracking may furthermore be integrated. As a man-machine interface, the total station may comprise an electronic display/control unit—generally a microprocessor computation unit with an electronic data memory means—having a display and input means, for example a keypad. The display/control unit is supplied with the measurement data recorded by electrical sensors, so that the position of the target point can be determined, optically displayed and stored by the display/control unit. Total stations known from the prior art may furthermore have a radio data interface for setting up a radio link to external peripheral components, for example to the measurement aid instrument or to a hand-hold data recording apparatus, which may for example be configured as a data logger or field computer.

In order to sight or target the target point to be surveyed, geodetic surveying apparatuses of the generic type comprise a target telescope, for example an optical telescope, as a sighting device. The target telescope is generally rotatable about a vertical upright axis and a horizontal tilt axis relative to a base of the measuring apparatus, so that the telescope can be aligned with the point to be measured by swivelling and tilting. In addition to the optical viewing channel, modern apparatuses may comprise a camera for recording an image, integrated into the target telescope and for example aligned coaxially or parallel, in which case the recorded image may in particular be represented as a live image on the display of the display/control unit and/or on a display of the peripheral apparatus—for example the data logger—used for remote control.

Current surveying apparatuses by now comprise an automatic target tracking function for prisms used as a target reflector (ATR: “Automatic Target Recognition”) as standard. To this end, for example, a further separate ATR light source and a special ATR detector (for example a CCD surface sensor, a CMOS image sensor (CIS) or SPAD array) sensitive to this wavelength are additionally integrated in the telescope.

In many geodetic applications, surveying of points is carried out by placing a specially configured measuring aid instrument or target objects (for example surveying rods) at the target point. This usually consists of a pole with a reflector (for example an all-round prism or 360-degree prism) for definition of the measurement path, or of the measurement point. For such surveying tasks, data, instructions, speech and further information items are typically transmitted between the target object and the central measuring apparatus in order to control the measurement process and in order to establish or register measurement parameters. Examples of such data are identification information items for the target object (from example of the type of prism used), the inclination of the pole, the height of the reflector above the ground, reflector constants or measurement values such as temperature or air pressure. These information, or situation-contingent parameters are required in order to allow highly precise targeting and surveying of the measurement point defined by the pole with a prism.

In addition, determination of the spatial orientation or an inclination relative to respectively relevant spatial directions of the respective aid instrument is required or to be adjusted in a defined way (for example vertically), in order together with the determined position of the reflector arranged on the aid instrument to derive the measurement point to be determined by means of the instrument. Such orientation may, for example, be determined by means of an inclination sensor which is provided in a determined position and placement relative to the reflector.

The use of inclination sensors allows simple position determination in two rotational degrees of freedom. In this way, a roll and a pitch of the measuring aid instrument, i.e. a respective rotation about respective horizontal axes, may be determined.

A disadvantage of known surveying targets like an all-round prism typically is that these targets are of comparatively heavy weight. Such heavy weight results from the long-range requirement of the retro-reflector. They enable 3D measurement in field typically up to distance of 300 m from any direction within a range of 360° in yaw and 60° in pitch without adjustment of target orientation. To provide such properties, this type of target is typically constructed with six glass corner-cubes which are polished by high precision machines and assembled manually and are therefore expensive to produce. In consequence, the amount of glass prisms (6 or 8) as well as the supporting structure to protect against shock also contribute to a relatively large weight.

Moreover, for many use cases, a GNSS antenna needs to be mounted on top of the target and the mechanical construction must be sufficiently robust so that the pole can withstand topple over with GNSS antenna. To achieve that, the 360° target has usually a large size and is quite heavy. Another drawback of a corner cube is, that a lateral aiming error of an ATR camera is high due to the refraction effects and flying spots mostly caused by 2-fold reflection (instead of regular 3-fold reflections) at prism corners. The arrangement of six individual prisms also causes errors since the apparent locations of the prisms are not in the same point. This is because of a radial offset from the pole axis and a vertically offset between an upper and a lower prism group.

### SUMMARY

It is therefore an object of the present disclosure to provide an improved reflector arrangement which allows reliable and robust measurement while avoiding above disadvantages.

A further object of the present disclosure is to provide an improved reflector arrangement which provides improved retro-reflecting properties over a wide angular range (field of view) and which has improved handling properties, in particular regarding weight and mounting stability.

The disclosure relates to a reflector arrangement for determining a position of a target point and/or for marking a target point, in particular for industrial or geodetic surveying. The reflector arrangement has at least two retro-reflecting elements, wherein each of the at least two retro-reflecting elements comprises a respective front boundary surface configured for entry of measuring light into the respective retro-reflecting element and a respective back boundary surface configured for reflecting the measuring light as reflected measuring light. The front boundary surface and the back boundary surface are arranged on opposite sides of the respective retro-reflecting element. Further, each of the at least two retro-reflecting elements comprises a respective optical axis defined by the arrangement of the front boundary surface and/or the back boundary surface of the respective retro-reflecting element.

The front boundary surface and the back boundary surface of each of the at least two retro-reflecting elements are of curved shape. In particular, the front boundary surface is of convex curvature regarding an illumination direction of the measuring light and the back boundary surface is of convex shape. In particular, the curvature centers of the front boundary surface and the back boundary surface are at the same location to provide a monocentric optical design.

For each of the at least two retro-reflecting elements an incidence angle of the measuring light relative to its optical axis is equal to an exit angle of the reflected measuring light relative to its optical axis. This means, the incoming light is retro-reflected (parallel).

Since there may be an offset between the incoming and the reflected measuring light, respective incidence and exit angles at the curved front boundary surface may be different. However, the incidence angle and the exit angel with respect to the reflector arrangement are equal. In other words, the directions of measuring light and reflected light are diametrical.

The measuring light preferably is provided as collimated laser light, in particular emitted by a measuring device like a surveying device (e.g. total station or laser scanner) or a metrology device (e.g. laser tracker). The laser light may be of particular wavelength, e.g. having a wavelength of the visible spectrum VIS (e.g. 658 nm) or of the infrared spectrum IR.

In one embodiment, the back boundary surface can provide a coating to provide reflectivity. The coating may be a dielectric or metal coating. The coating can be provided on the back boundary surface of the retro-reflecting element.

In one embodiment, at least two of the retro-reflecting elements can be arranged with different orientations. In one embodiment, the reflector arrangement can comprise a plurality of the retro-reflecting elements which are arranged each with a particular orientation different from the orientation of the other retro-reflecting elements. An orientation of a retro-reflecting element can preferably be defined by its optical axis and a facing direction of the reflective back boundary surface.

In an embodiment, each of the at least two retro-reflecting elements can be arranged with a particular orientation different from the orientation of the other retro-reflecting elements. Additionally or alternatively, the optical axes of each of the at least two retro-reflecting elements are provided with different orientations.

In an alternative embodiment, at least two of the retro-reflecting elements can be arranged with identical orientations. This may in particular be the case when the reflector arrangement comprises cylindrical shape and the beads (retro-reflecting elements) are not tilted up or down.

In one embodiment, at least one of the retro-reflecting elements can be configured so that the measuring light entering into the retro-reflecting element at the front boundary surface is focussed on the back boundary surface.

According to one embodiment, the front boundary surface and the back boundary surface of at least one of the retro-reflecting elements can be of spherical shape. According to some embodiments, at least one of the boundary surfaces, the front and/or the back boundary surface may be spherically, ellipsoidally, paraboloidally or hyperboloidally formed.

According to an embodiment, at least one of the retro-reflecting elements can comprise a sphere with a refraction index n, wherein 1.9<n<2.1, in particular wherein n=2 or n˜2 (n being around 2; n being a function of lamda λ). In particular, the sphere provides the front boundary surface and the back boundary surface. The sphere can be made of optical material which allows to manipulate propagation of the measuring light in a way so that the measuring light is focussed onto the (inner) back boundary surface by entering and passing through the sphere (e.g. by refraction).

In particular, the retro-reflecting element can be made of glass.

According to one embodiment, at least one of the retro-reflecting elements can comprise at least two optical elements, wherein the front boundary surface is provided by a first of the at least two optical elements and the back boundary surface is provided by a second of the at least two optical elements. In particular, each of the at least two optical elements can have a refractive index n of n<2.1.

In particular, the front boundary surface can comprise a radius of curvature different from the radius of curvature of the back boundary surface. The radius of curvature of the front boundary surface can preferably be smaller than the radius of curvature of the back boundary surface.

In one embodiment, each of the at least two optical elements can define a centre point, in particular an optical or a geometric centre, and the at least two optical elements can be arranged so that the centre points of the at least two optical elements coincide and a monocentric distance between the front boundary surface and the back boundary surface is provided. Such a monocentric design provides that the chief ray from any field angle travels through the same centre point of a monocentric system. Hence, the focusing and retro-reflecting performance over the complete FOV is constant thanks to the spherical symmetry. The same focusing and retro-reflecting performance is realisable with larger aperture, whereas the size can be kept significantly smaller than classical imaging lenses.

In one embodiment, each of the at least two optical elements can be configured so that the centre points of the at least two optical elements are provided with a particular offset and a distance between the front boundary surface and the back boundary surface is smaller than the monocentric distance. By that, an apochromatic retro-reflecting element can be provided regarding particular measuring and illumination wavelengths of a surveying device.

According to one embodiment, the reflector arrangement can comprise a carrier to carry the at least two retro-reflecting elements. The at least two retro-reflecting elements are arranged at the carrier.

In particular, the carrier can comprise a central mount and the at least two retro-reflecting elements can be arranged with different orientation directions, in particular wherein the mount is provided by a rod extending through the carrier. The mount can preferably be designed to connect a further component with the reflector arrangement. In particular, the mount can be arranged (oriented) and configured to hold a GNSS antenna on top of the reflector arrangement.

In one embodiment, the carrier can comprise a spherical or cylindrical shape and can comprise at least two recesses. Each recess can be configured to carry one retro-reflecting element and one respective retro-reflecting element can be arranged at each recess. In particular, the carrier can comprise a plurality of recesses and the recesses are homogeneously and/or equidistantly distributed over (with respect to) the surface of the carrier.

The carrier can be built in lightweight design. The carrier can for instance comprise a lightweight metallic material, e.g. aluminium, or can even be made from it. Using such material to build the carrier provides improved robustness and structural stability of the carrier and the entire reflector arrangement. By that, a GNSS antenna can comparatively easily be mounted on the carrier. Further, due to the spatial extension of the carrier a rod-like mount can be arranged at least partly inside of the carrier, in particular extending throughout the entire carrier to also provide mounting of the reflector arrangement on e.g. a surveying pole.

The disclosure also relates to a retro-reflecting element for a reflector arrangement of above. The retro-reflecting element comprises a front boundary surface configured for entry of measuring light into the retro-reflecting element and a back boundary surface configured for reflecting the measuring light as reflected measuring light, wherein the front boundary surface and the back boundary surface are arranged on opposite sides of the retro-reflecting element. An optical axis is defined by the arrangement of the front boundary surface and/or the back boundary surface of the retro-reflecting element.

The front boundary surface and the back boundary surface of the retro-reflecting element are of curved shape. The retro-reflecting element comprises a mounting element arranged at the back boundary surface and protruding from the back boundary surface, the mounting element provides mounting of the retro-reflecting element at the reflector arrangement.

The design of such a retro-reflecting element provides efficient and precise arrangement of one or a plurality of such retro-reflecting element e.g. at a carrier of the reflector arrangement. Hence, the components of the reflector arrangement can be manufactured separately and combined in a later step. Further, in case of damage of one of the retro-reflecting elements the respective element can be replaced quickly, and precision of the reflector arrangement can be restored.

In one embodiment, the mounting element can comprise a first end and a second end, wherein the first end comprises a reflecting surface facing away from the mounting element, the first end is attached to the back boundary surface, and the reflecting surface of the first end provides the reflecting back boundary surface. In particular, the second end is configured to be connected to a recess of the reflector arrangement.

As for example, a pin (mounting element) can have a reflective concave spherical shape at one end. The pin can be fixed with an optical transparent adhesive to an optical element of the retro-reflecting element which optical element provides the back boundary surface. In particular, the optical element is embodied as a sphere, e.g. N2 sphere.

The disclosure also relates to a method of providing a reflector arrangement. The method comprises providing at least one retro-reflecting element, the retro-reflecting element comprises a front boundary surface configured for entry of measuring light into the retro-reflecting element, a back boundary surface configured for reflecting the measuring light as reflected measuring light, wherein the front boundary surface and the back boundary surface are arranged on opposite sides of the retro-reflecting element, and a mounting element arranged at and protruding from the back boundary surface.

The method also comprises providing a carrier with at least one recess to carry the at least one retro-reflecting element, wherein the recess is configured to receive the mounting element of the retro-reflecting element, and arranging a number of retro-reflecting elements corresponding to the number of recesses at the carrier by inserting each mounting element of the retro-reflecting elements into a respective recess.

In one embodiment, at least two recesses can be provided so that each recess comprises a particular orientation different from the orientations of the other recesses, wherein the orientation of a recess is defined by an inserting axis and an opening of the respective recess. The provision of the recesses with particular orientations provides for comparatively easy assembling of the reflector arrangement, since no additional alignment of the single reflecting elements becomes necessary.

The mounting element can be provided by a stud, a pin, a bolt, a rod or the like. In one embodiment, the mounting element can comprise a reflective end surface as described above.

In one embodiment, the method comprises providing a mounting plate which comprises at least one recess, providing an optically transparent bead in the recess, in particular optically transparent regarding a wavelength range related to particular measuring light, providing a sealing cover on the optically transparent bead to define a surface region of the bead to be coated and applying a reflective coating on the bead and, by that, providing a coated bead. Further, the method comprises providing a guiding plate with a guide on the coated bead, wherein the guiding plate and the mounting plate are arranged so that the guide is centrally arranged relative to the coated surface region of the coated bead, providing the mounting element in the guide so that the mounting element contacts the coated bead, applying an adhesive at the mounting element and at the coated bead to provide connection between the mounting element and the coated bead and by that providing the retro-reflecting element.

By manufacturing a retro-reflecting element according to the method above an initially non-reflective element can be processed, i.e. coated, to provide a reflective element. The initial element is chosen with respect to material, dimension, and shape so that the coating already provides a retro-reflective element. In addition, the method also provides to precisely connect and orientate a mounting element relative to the coated region of the retro-reflecting element. In particular, the mounting element is connected and oriented so that an extension of the mounting element is parallel to the optical axis of the retro-reflecting element. The mounting element preferably is arranged on the back boundary surface and points away from the coated region.

The disclosure also relates to a reflector arrangement for determining a position and/or for marking a target point, in particular for industrial or geodetic surveying, which is obtained by executing the method of above.

### BRIEF DESCRIPTION OF THE DRAWINGS

The inventive aspects are described or explained in more detail below, purely by way of example, with reference to working examples shown schematically in the drawing. Identical elements are labelled with the same reference numerals in the figures. The described embodiments are generally not shown true to scale and they are also not to be interpreted as limiting. Specifically,

FIG. 1: shows a geodetic surveying system having a reflector arrangement;

FIG. 2: shows an exemplary embodiment of a reflector arrangement;

FIG. 3a-b: show further exemplary embodiments of a reflector arrangement;

FIG. 4a-b: show embodiments of retro-reflecting elements of a reflector arrangement;

FIG. 5a-c: show an approach to adjust optical properties of a retro-reflecting elements of a reflector arrangement;

FIG. 6a-b: show an approach to adjust optical properties of a retro-reflecting elements of a reflector arrangement; and

FIG. 7a-c: show an assembly approach for a reflector arrangement.

### DETAILED DESCRIPTION

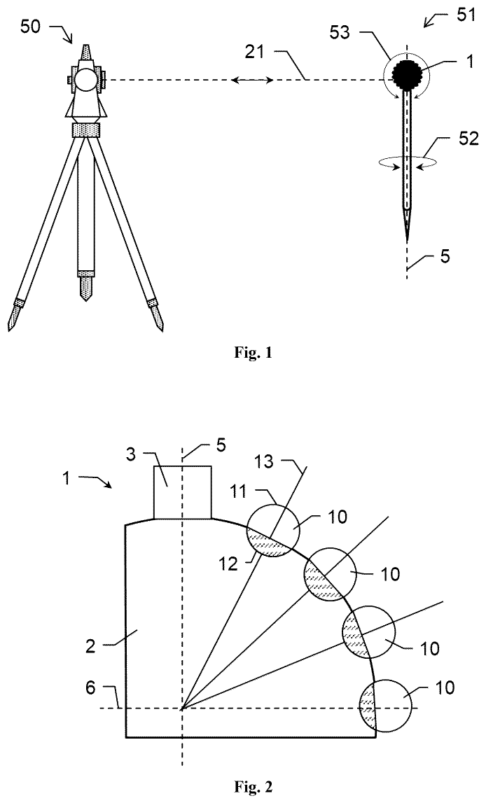

FIG. 1 shows a surveying apparatus 50, in particular configured as a total station or multi station, having a base, a supporting unit, which can be swiveled relative to the base about a vertical swivel axis, and a targeting unit which can be rotated about a horizontal axis and, by means of the supporting unit, about the vertical axis. A measurement laser beam 21 (measuring light) is emitted from the targeting unit and strikes a reflector arrangement 1 of a measuring aid instrument 51 configured as a pole. Typically, (collimated) laser radiation, which can be generated by a laser diode or gas laser provided on the surveying apparatus 50, is used as the measuring light 21. The reflector arrangement 1 is built as a retroreflector and is shown and described in more detail below.

For range measurement, the measuring light 21 is reflected back parallel by the retroreflector, recorded by the surveying apparatus 50 and evaluated in respect of distance information, for example by means of a time-of-flight measurement. The position of the measuring aid instrument 51 may be determined with the aid of the determination of the angular setting of the targeting unit, i.e. the emission direction of the laser 21.

The reflector arrangement 1 of the measuring aid instrument 51 comprises a plurality of retro-reflecting elements, wherein each of these elements comprises a front boundary surface and the reflectively coated back boundary surface of curved shape and an incidence angle of the measuring light 21 relative to its optical axis is equal to an exit angle of the reflected measuring light relative to its optical axis. The retro-reflecting elements are arranged with different orientations. By that, a retro-reflector providing 360° (horizontal) angular range of retro-reflection 52 (similar to field of view) around a yaw axis 5 (carrier axis) can be provided. Moreover, a comparatively large angular range of retro-reflection 53 (field of retro-reflection) around a pitch axis (orthogonal relative to the yaw axis 5) is provided. This also provides a big advantage for some use cases where there is large height difference between a target (comprising the reflector arrangement) and a surveying device.

FIG. 2 shows an exemplary embodiment of a reflector arrangement 1. The reflector arrangement 1 is partially shown and is shown in cross-section view.

The reflector arrangement 1 comprises a plurality of retro-reflecting elements 10. Each of the retro-reflecting elements 10 comprises a front boundary surface 11 (exemplarily shown only for one of the retro-reflecting elements) which is configured and oriented for entry of measuring light into the respective retro-reflecting element 10. In addition, each of the retro-reflecting elements 10 comprises a respective back boundary surface 12 configured for reflecting the measuring light as reflected measuring light. The front boundary surface 11 and the back boundary surface 12 are arranged on opposite sides of the retro-reflecting element 10.

Each of the retro-reflecting elements 10 defined an optical axis 13 by its front boundary surface 11 and back boundary surface 12. In particular, the optical axis 13 intersects a centre point of the retro-reflecting element 10 and a centre point of the back boundary surface 12. The centre point of the back boundary surface 12 is preferably defined by a centre point of a reflectively coated region which represents the back boundary surface 12.

In another embodiment, the backside of the retro-reflecting elements is not coated but reflectivity may be provided by alternative solutions, e.g. a mounting element with a reflective end attached to the retro-reflecting elements or a reflective inner surface of a recess of the carrier.

The front boundary surface 11 and the back boundary surface 12 are of curved shape. According to the shown embodiment the retro-reflecting elements 10 are designed as spheres, wherein a reflective coating is arranged on one side of the sphere and the opposite side is optically transparent for measuring light of a particular wavelength or wavelength range.

The retro-reflecting elements 10 are further configured so that an incidence angle of the measuring light relative to the optical axis 13 is equal to an exit angle of the reflected measuring light relative to the optical axis 13, i.e. the measuring light is retro-reflected.

Furthermore, the reflector arrangement 1 comprises a carrier 2. The retro-reflecting elements 10 are mounted on the carrier 2, wherein each of the retro-reflecting elements 10 provides a particular orientation different from the orientations of the other retro-reflecting elements 10.

In the embodiment shown the carrier 2 provides a spherical shape and the retro-reflecting elements 10 are homogeneously and/or equidistantly distributed over the surface of the carrier 2. As shown, the retro-reflecting elements 10 are arranged so that the back boundary surfaces 12 of the elements 10 face the centre of the spherical carrier 2 and the front boundary surfaces 11 point away from the carrier 2. In particular, the retro-reflecting elements 10 are arranged so that their optical axes 13 intersect in one common intersection region (e.g. having a spatial tolerance of about 2 mm) or point, wherein the intersection point coincidences with the centre point of the carrier 2.

One benefit of this embodiment is that lateral measurement can become pitch-independent since the center of gravity of the signal (related to an ATR camera image) remains centered as the carrier 2 rotates. This may, in particular, be advantageous compared to a cylindrical arrangement where the signal may move up/down since all spheres reflect with the same strength and are offset from the pole axis.

The carrier 2 further comprises a central mount 3. The mount 3 can preferably be arranged so that an additional surveying element, e.g. a GNS or GNSS antenna can be mounted on top of the carrier 2.

The carrier can comprise or can be manufactured of a metal-containing material, in particular can be made of an aluminium based material. By that, the carrier 2 can provide structural robustness and stability as well as comparatively low weight. By using aluminum, the mechanical structure of carrier can be designed in such way that the total weight is lower than tradition prism where the most volume is occupied with massive glass.

The mount 3 can be attached on top of the carrier 2 or can extend into the inner volume of the carrier 2, in particular can extend through the whole carrier.

The design of the reflector arrangement 1 provides retro-reflection of measuring light over a wide angular range, in particular over 360° (yaw angle) around a carrier axis 5 (yaw axis) and over up to 180° around a pitch axis 6, which is orthogonally oriented relative to the carrier axis 5.

The retro-reflection of measuring light is provided by at least one of the retro-reflecting elements 10. In particular, retro reflecting the measuring light can be provided simultaneously by at least two or by a plurality of the retro-reflecting elements 10. The amount and/or which of the retro-reflecting elements 10 provide reflection depends on an incidence angel (in particular also on an offset) of the measuring light relative to the reflector arrangement 1. In other words, when an incidence angel of the measuring light changes, the retro-reflecting elements 10 which contribute to total retro-reflection also change.

The idea of the reflector arrangement 1 (in the following also: bead reflector) is to arrange at least two, preferably multiple, beads (retro-reflecting elements 10) e.g. in spherical layout to cover a sufficient angular range (FOV), in particular at least close to 4 π solid angle. The FOV of each bead is designed to be large enough to have overlap with enough neighbourhood beads. In contrast to typical corner cube retro-reflectors, here the retroreflecting mechanism is based on refraction instead of reflection. The incoming light can be focused on the rear surface of each bead and reflected back to a receiver. Each bead can behave like an afocal imaging lens. Its aberration is preferably chosen to be as less as possible within the complete FOV to achieve constantly bright signal independent of reflector orientation. In other words, each bead provides large aperture, large FOV, constantly good imaging performance and at the same time small size and weight.

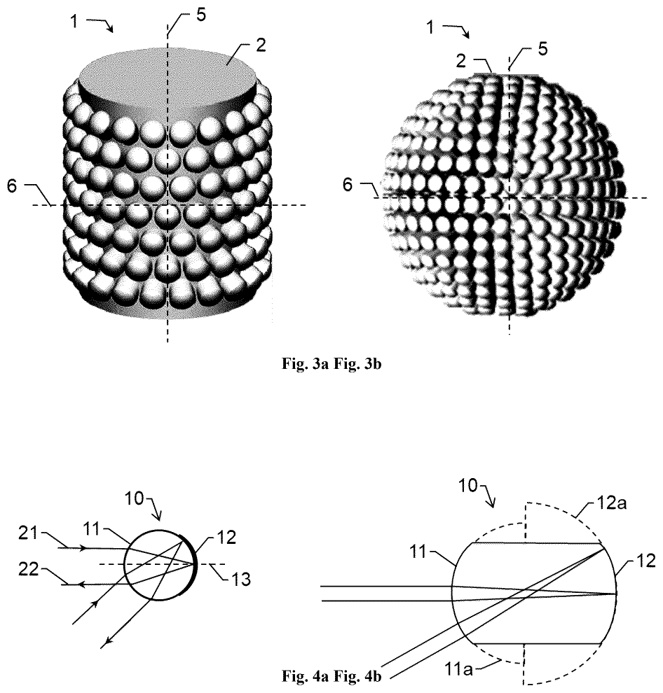

FIGS. 3a and 3b exemplary show two further embodiments of reflector arrangements 1.

FIG. 3a shows a reflector arrangement 1 with a carrier 2, wherein the carrier provides a cylindrical shape. A plurality of retro-reflecting elements 10 are arranged at the carrier 2. The retro-reflecting elements 10 are arranged with different orientations so that measuring light directed towards the reflector arrangement 1 is retro-reflected over a wide field of view.

The particular design of the reflector arrangement 1 provides retro-reflection over 360° about the carrier axis 5. Moreover, due to the orientations of the retro-reflecting elements 10, the range of (sufficient) retro-reflection about the pitch axis 6 is still comparatively large, i.e. retro-reflection can be provided over up to 120° (±60°) or even up to 140° (±70°).

In an alternative embodiment, the retro-reflecting elements 10 are oriented along the normal of the cylinder surface, i.e. not tilted up/down. This may provide easier manufacturing of the assembly and/or a stronger signal at normal incidence while still a sufficient FOV can be provided since each bead has a large angle range.

FIG. 3b shows a reflector arrangement 1 with a carrier 2, wherein the carrier provides a spherical shape. A plurality of retro-reflecting elements 10 are arranged at the carrier 2. The retro-reflecting elements 10 are arranged with different orientations so that measuring light directed towards the reflector arrangement 1 is retro-reflected over a wide field of view.

Compared with the design of the reflector arrangement 1 of FIG. 3a, here the total retro-reflection range related to pitch and yaw axes can further be enlarged. The retro-reflecting elements 10 can be oriented over a wider range related to a pitch angel thanks to the spherical shape. In particular in the upper and lower regions of the carrier 2 the retro-reflecting elements 10 can even be oriented to face straight upwards and/or straight downwards, i.e. with an angle of orientation of +90° or −90° related to the pitch axis 6.

Moreover, the design of the spherical carrier 2 provides an advantageous manufacturing approach where each of the retro-reflecting elements 10 can be oriented with its respective optical axis coaxial with the surface normal which is defined by the surface region at which the retro-reflecting elements 10 is arranged. The spherical shape allows to efficiently provide recesses to respectively mount the retro-reflecting elements 10, e.g. by (orthogonally) drilling in the carrier.

In alternative embodiments (not shown) the reflector arrangement 1 with a carrier 2 can provide a non-homogenous arrangement of the plurality of retro-reflecting elements 10 (beads) over the carrier 2. By that, retro-reflection over wide angular ranges (as described above) can still be provided. In addition, such inhomogeneous (but known) distribution of the retro-reflecting elements 10 can provide to also determine the orientation of the reflector arrangement 1.

As for example, an image of the (illuminated and, by that, reflecting) reflector arrangement 1 can be captured and, by that, the reflections of a group of retro-reflecting elements 10 can be imaged. The image can be processed and a pattern of the reflections can be determined based on the image. According to the inhomogeneous arrangement of the retro-reflecting elements 10, such pattern can be unambiguously assigned to the group of retro-reflecting elements 10 (which respectively are arranged at the carrier 2 with a corresponding pattern). As a result, the orientation of the reflector arrangement 1 can be derived based on the shape and/or orientation of the pattern in the image.

Further, particular intensities of the reflections can be considered in the course of image processing to derive the detected group of retro-reflecting elements 10.

The retro-reflecting elements 10 can also be designed to provide different and/or individual reflectivity. Such variations in reflectivity can be detected and resolved (in the image by image processing). In consequence, the orientation of the reflector arrangement 1 can also be derived based on a pattern of reflectivity.

The above approaches of determining the orientation of the reflector arrangement 1 can preferably be applied with measurements of a surveying device of up to a distance of about 50 m. Here, focussing an ATR of the surveying device can provide to resolve the retro-reflecting elements 10.

FIGS. 4a and 4b exemplary show two embodiments of bead-like retro-reflecting elements 10 of a reflector arrangement.

FIG. 4a shows an embodiment of a retro-reflecting element 10 with a front boundary surface 11 and a back boundary surface 12. The retro-reflecting element 10 comprises a spherical shape, in particular the retro-reflecting element 10 is built as a sphere.

The retro-reflecting element 10 is provided as a ball lens with a refractive index at least close to 2. By fine tuning of the refractive index, the position of the focal plane can be adjusted against the wavelength. The ball radius can be chosen freely, as the focal plane always coincide with the ball surface independent of the ball radius. Hence, the ball lens can have an angular range of retro-reflectivity (field of view (FOV)) of ±90 degrees.

In the shown embodiment, the reflective back boundary surface 12 is coated with a metallic coating. In particular, the coating covers the hemisphere. The coating provides a reflectivity of at least 95% within a nearly 2 π solid angle.

The advantage properties of the bead-like retro-reflecting element 10 are, e.g. a large aperture, a large FOV, a good imaging performance, and at the same time a small size and weight, that can be provided by the given monocentric design of the retro-reflecting element 10. A monocentric design is characterised with all its components (including stop, lenses and image plane) shaped and positioned spherical-symmetrically against a single centre point where the stop is located virtually. The chief ray from any field angle travels through the same centre point of a monocentric system. The imaging performance over the complete FOV can be constant thanks to the spherical symmetry., these properties are provided by one single optical lens with two optical surfaces.

Measuring light 21, e.g. emitted by a surveying device like a total station or tachymeter, can be provided to enter the bead 10 at the front surface 11. The measuring light 21 is focussed onto the back boundary surface 12 and is reflected back as reflected measuring light 22. The incidence angles of the entering measuring light 21 and the reflected measuring light 22 relative to the optical axis 13 of the bead 10 are identical.

FIG. 4b shows a further embodiment of a retro-reflecting element 10 with a front boundary surface 11 and a back boundary surface 12. Here, the retro-reflecting element 10 comprises an elongated shape.

The elongated retro-reflecting element 10 has two spherical surfaces, i.e. the front boundary surface 11 and the back boundary surface 12, with different radii. The radius 11a of the front boundary surface 11 is smaller than the radius 12a of the back boundary surface 12.

The curvature centres of both surfaces 11 and 12 are at the same position, and therefore the design is monocentric too. The radius of the back surface 12 is accordingly adapted to the refractive index of the optical material and curvature radius of front surface in such way that the focal plane coincides with the back surface 12. The choice of the refractive index is therefore flexible so that any type of plastic and glass material is usable. The refractive index is preferably be chosen to be smaller than 2.

By that, the retro-reflecting element 10 can be manufactured easier and more efficiently. Glass and plastic moulding is a preferred technology rather than classical grinding and polishing (e.g. PGM, precision glass moulding).

FIGS. 5a-c show an approach of how to adjust the optical properties of a retro-reflecting element 10 to meet specific characteristics required to be used with a surveying device.

A surveying device like a total station can provide three optical subsystems (EDM, ATR and Power Search) running at three different wavelengths (e.g. 658 nm, 785 nm and 850 nm). To achieve constantly good radiometry over a spectral range of about 200 nm the configuration of the retro-reflecting element 10 can be specifically adjusted to overcome negative influences, e.g. due to the dispersion of the manufacturing material.

The radiometric response against wavelengths change is asymmetric. The radiometry toward longer wavelength is reduced significantly slower than moving toward the opposite direction (see FIG. 5a). When moving in the slowly changing direction, radiometry remains around 20% of total power on a detector after reflection over a broad spectral range of several hundred nanometres.

According to this finding, it is proposed to design an achromatic bead 10 by shifting the response curve in such way so that the three relevant wavelengths are located at the right side of the peak position.

The elongated retro-reflecting element 10 is designed so that a negative thickness offset is introduced for the bead design. In other words, a regular distance between the front boundary surface 11 and the back boundary surface 12 (as shown in FIG. 4b) is reduced (see FIG. 5b).

As a result, the distribution of power at the detector is shifted relative to the measuring wavelengths so that for each of the wavelengths the power at the detector is at least 10-20% of the detectable peak power (see FIG. 5c).

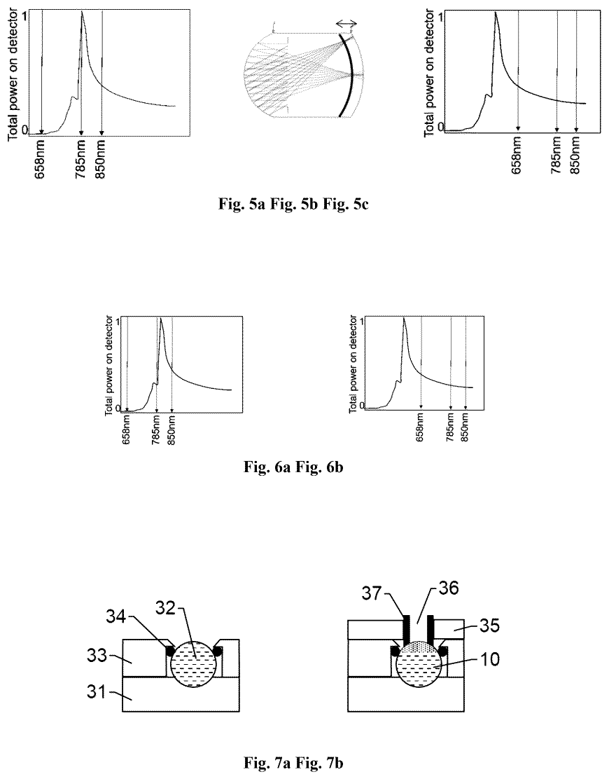

FIGS. 6a-b show a further approach of how to adjust the optical properties of a retro-reflecting element 10 to meet specific characteristics required to be used with a surveying device.

Here, the retro-reflecting element is built as a sphere or bead (as shown in FIG. 4a). It was found that for meeting optical surveying properties, the retro-reflecting element 10 should preferably be configured as a ball-lens made from optical material which has an adjusted refractive index. Retro-reflection properties of the retro-reflecting element 10 directly depend on the refractive index.

As can be seen from FIG. 6a the total power of measuring light with a wavelength of 658 nm results to near zero after reflection at a sphere having a refractive index of about 2.022. Hence, for instance, the measuring light of a total station used of determining the distance to a reflector (having a wavelength of 658 nm) would be reflected with insufficient intensity. A solution for this problem was found by changing the optical material of the bead and by that changing the refractive index.

In consequence, the retro-reflecting element 10 can be made from material which provides a slightly different refractive index of 2.0033. By that, the reflection properties of the retro-reflecting element 10 are shifted so that all three relevant wavelength regions can be reflected by providing sufficient power at a detecting unit after reflection at the bead 10. As for example, by choosing glass with a refractive index n=2.0033 for the bead design thickness variations (diameter variations of the sphere) have no impact on the wavelength dependency. This is one advantage of the spherical shape compared to a design with different radii.

Respective tuning of the refractive index of the material can be a consequence of spherical aberrations effects. The reflected ray 22 may only be parallel to the incoming 21 for a limited range of incidence angles/offsets from the bead's optical axis. E.g. for the wavelength where n=2, rays close to the center of the bead are retro-reflected, but for longer wavelengths the refractive index becomes n<2 and retro-reflection occurs at larger offsets where spherical aberration adds additional refractive power. At shorter wavelength with n>2, the retro-reflective effect vanishes.

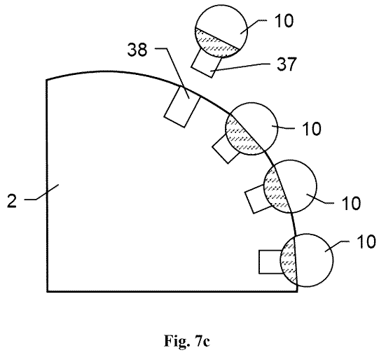

FIGS. 7a-c show an approach of how to manufacture a reflector arrangement 1 with a plurality of retro-reflecting elements 10. First, the retro-reflecting elements 10 have to be manufactured to provide sufficient retro-reflectivity and, in a next step, the retro-reflective elements have to be arranged at the reflector arrangement 1 with particular orientations.

A mounting plate 31 is provided. The plate 31 comprises at least one recess and an optically transparent bead 32 is arranged in the recess. Here, optically transparent is referred to a wavelength range related to a particular measuring light of a surveying device as mentioned above. Next, a sealing cover 33 is put on the optically transparent bead 32 to define a surface region of the bead to be coated. The sealing cover 33 comprises a seal 34 or distance ring, e.g. an O-ring or the like, which contacts the bead 32 and, by that, separates a portion of the bead 32 (see FIG. 7a).

This arrangement provides to coat the sealed region by applying a reflective (mirror) coating. The coating can be applied by spraying, painting or other deposition techniques. In particular, the coating is dried or cured afterwards. A coated retro-reflecting element 10 results from this procedure.

In a next step, a guiding plate 35 with a guide 36 is provided on the coated bead 10, wherein the guiding plate 35 and the mounting plate 31 are arranged so that the guide 36 is centrally arranged relative the coated surface region of the bead 10.

An essential step is to glue a guiding stud 37 (mounting element) within single step directly after coating the bead. Hence, a stud 37 is provided in the guide 36 so that the stud 37 contacts the coated bead 10. Instead of a stud also a bolt or a pin or the like can be used.

An adhesive (e.g. glue) is applied so that it covers at least a part of the stud and at least a part of the coated bead 10 to provide connection between the stud 37 and the coated bead 10 (see FIG. 7b). As for example, if the stud is provided as hollow guiding stud it can be glued centrally on the top of coating area and the adhesive can be applied through the hole of the stud 37.

By avoiding any active alignment of the coated bead and or the stud a cost-effective, scalable, precise and robust assembly concept can be provided.

As mentioned, the alignment accuracy between a stud axis and the coating area is guaranteed by the precisely positioned guiding plate 33. The connected guiding stud 37 allows effortless and automated assembly of coated ball lenses 10 in the bead carrier 2, as shown with FIG. 7c. This procedure can be conducted and parallelized to achieve high volume and high throughput via using state-of-the-art machine automation and/or robotics.

The retro-reflecting element 10 with the glued stud can easily be arranged at a carrier 2 of a reflector arrangement 1. For that, the carrier can comprise several recesses 38, wherein each recess 38 is configured to carry one retro-reflecting element 10 (see FIG. 7c). Such assembly can guarantee a desired distribution of the retro-reflecting element 10 over the carrier 2 by respective arrangement of the recesses 38. Furthermore, due to the individual configuration of the retro-reflecting elements 10 the desired orientation of each of these elements 10 can also be provided in reliable and robust manner.

Although aspects are illustrated above, partly with reference to some preferred embodiments, it must be understood that numerous modifications and combinations of different features of the embodiments can be made. All of these modifications lie within the scope of the appended claims.

1. A reflector arrangement for determining a position and/or for marking a target point, in particular for industrial or geodetic surveying, having at least two retro-reflecting elements, wherein each of the at least two retro-reflecting elements comprises:
a respective front boundary surface configured for entry of measuring light into the respective retro-reflecting element and a respective back boundary surface configured for reflecting the measuring light as reflected measuring light, wherein the front boundary surface and the back boundary surface are arranged on opposite sides of the respective retro-reflecting element, and
a respective optical axis defined by the arrangement of the front boundary surface and/or the back boundary surface of the respective retro-reflecting element, wherein:
the front boundary surface and the back boundary surface of each of the at least two retro-reflecting elements are of curved shape, and
for each of the at least two retro-reflecting elements an incidence angle of the measuring light relative to its optical axis is equal to an exit angle of the reflected measuring light relative to its optical axis.

2. The reflector arrangement according to claim 1, wherein:
at least two of the retro-reflecting elements are arranged with different orientations, wherein each of the at least two retro-reflecting elements is arranged with a particular orientation different from the orientation of the other retro-reflecting elements, and/or
the reflector arrangement comprises a plurality of the retro-reflecting elements which are arranged each with a particular orientation different from the orientation of the other retro-reflecting elements, and/or
the optical axes of each of the at least two retro-reflecting elements are provided with different orientations.

3. The reflector arrangement according to claim 1, wherein at least one of the retro-reflecting elements is configured so that the measuring light entering into the retro-reflecting element at the front boundary surface is focussed on the back boundary surface.

4. The reflector arrangement according to claim 1, wherein:
the front boundary surface and the back boundary surface of at least one of the retro-reflecting elements are of spherical shape, and/or
at least one of the retro-reflecting elements comprises a sphere with a refraction index n of 1.9<n<2.1, in particular wherein n=2.

5. The reflector arrangement according to claim 1, wherein at least one of the retro-reflecting elements comprises at least two optical elements, wherein the front boundary surface is provided by a first of the at least two optical elements and the back boundary surface is provided by a second of the at least two optical elements.

6. The reflector arrangement according to claim 5, wherein each of the at least two optical elements have a refractive index n of n<2.1.

7. The reflector arrangement according to claim 5, wherein the front boundary surface comprises a radius of curvature different from the radius of curvature of the back boundary surface.

8. The reflector arrangement according to claim 7, wherein the radius of curvature of the front boundary surface is smaller than the radius of curvature of the back boundary surface.

9. The reflector arrangement according to claim 5, wherein each of the at least two optical elements has a centre point and the at least two optical elements are arranged so that:
the centre points of the at least two optical elements coincide and a monocentric distance between the front boundary surface and the back boundary surface is provided, or
the centre points of the at least two optical elements are provided with a particular offset and a distance between the front boundary surface and the back boundary surface is smaller than the monocentric distance.

10. The reflector arrangement according to claim 1, wherein the reflector arrangement comprises a carrier to carry the at least two retro-reflecting elements and the at least two retro-reflecting elements are arranged at the carrier.

11. The reflector arrangement according to claim 10, wherein the carrier comprises a central mount and the at least two retro-reflecting elements are arranged with different orientation directions, in particular wherein the mount is provided by a rod extending through the carrier.

12. The reflector arrangement according to claim 10, wherein the carrier comprises a spherical or cylindrical shape and at least two recesses, wherein:
each recess is configured to carry one retro-reflecting element and
one respective retro-reflecting element is arranged at each recess.

13. The reflector arrangement according to claim 12, wherein the carrier comprises a plurality of recesses and the recesses are homogeneously and/or equidistantly distributed with respect to the surface of the carrier.

14. A retro-reflecting element for a reflector arrangement according to claim 1, wherein the retro-reflecting element comprises:
a front boundary surface configured for entry of measuring light into the retro-reflecting element and a back boundary surface configured for reflecting the measuring light as reflected measuring light, wherein the front boundary surface and the back boundary surface are arranged on opposite sides of the retro-reflecting element, and
an optical axis defined by the arrangement of the front boundary surface and/or the back boundary surface of the retro-reflecting element, wherein:
the front boundary surface and the back boundary surface of the retro-reflecting element are of curved shape, and
the retro-reflecting element comprises a mounting element arranged at and protruding from the back boundary surface, the mounting element provides mounting of the retro-reflecting element at the reflector arrangement.

15. The retro-reflecting element according to claim 14, wherein the mounting element comprises a first end and a second end, wherein:
the first end comprises a reflecting surface facing away from the mounting element,
the first end is attached to the back boundary surface, and
the reflecting surface of the first end provides the reflecting back boundary surface.

16. The retro-reflecting element according to claim 15, wherein the second end is configured to be connected to a recess of the reflector arrangement.

17. A method for providing a reflector arrangement comprising:
providing at least one retro-reflecting element, the retro-reflecting element comprises:
a front boundary surface configured for entry of measuring light into the retro-reflecting element,
a back boundary surface configured for reflecting the measuring light as reflected measuring light, wherein the front boundary surface and the back boundary surface are arranged on opposite sides of the retro-reflecting element, and
a mounting element arranged at and protruding from the back boundary surface,
providing a carrier with at least one recess to carry the at least one retro-reflecting elements, wherein the at least one recess is configured to receive the mounting element of the retro-reflecting element, and
arranging a number of retro-reflecting elements corresponding to the number of recesses at the carrier by inserting each mounting element of the retro-reflecting elements into a respective recess.

18. The method according to claim 17, wherein at least two recesses are provided so that each recess comprises a particular orientation different form the orientation of the other recesses, wherein the orientation of a recess is defined by an inserting axis and an opening of the respective recess.

19. The method according to claim 17, further comprising:
providing a mounting plate which comprises at least one recess,
providing an optically transparent bead in the recess, wherein the optically transparent bead is optically transparent regarding a wavelength range related to particular measuring light,
providing a sealing cover on the optically transparent bead to define a surface region of the bead to be coated,
applying a reflective coating on the bead and, by that, providing a coated bead,
providing a guiding plate with a guide on the coated bead, wherein the guiding plate and the mounting plate are arranged so that the guide is centrally arranged relative the coated surface region of the coated bead,
providing the mounting element in the guide so that the mounting element contacts the coated bead,
applying an adhesive at the mounting element and at the coated bead to provide connection between the mounting element and coated bead and by that providing the retro-reflecting element.

20. The reflector arrangement for determining a position and/or for marking a target point, obtained by executing the method according to claim 17.
